(19) United States
(12) Patent Application Publication
(10) Pub. No.: US 2007/0290385 A1
(43) Pub. Date: Dec. 20, 2007

(54) Blank for a Tooth Replacement Part and Method of Producing a Tooth Replacement Part

(76) Inventors: Stephan Holzner, Hohenschaftlarn (DE); Gerhard Weber, Purgen (DE)

Correspondence Address: IP STRATEGIES, 12 1/2 WALL STREET, SUITE I, ASHEVILLE, NC, 28801, US

(21) Appl. No.: 11/756,776

(22) Filed: Jun. 1, 2007

(30) Foreign Application Priority Data
Jun. 1, 2006 (DE) 102006025660.3

(51) Int. Cl. A61C 13/08

(52) U.S. Cl. 264/20

(57) ABSTRACT

The invention relates to a blank for a tooth replacement part comprising a first section having a shape of a section of a tooth or a tooth replacement part, and a second section comprising a material stock, which can be machined to a desired shape, e.g. by milling it off. The invention further relates to a method of producing a tooth replacement part, wherein a blank is machined by a removing process such as milling or laser machining to obtain a desired shape of a tooth replacement part, wherein only portions of the blank are machined while other portions remain unmachined because they already have the desired final shape. The invention also relates to a set comprising at least one above-defined blank and at least one counterpart, which is provided with a receptacle for holding the blank adapted at least partially to the first section and/or to the second section.

### FIELD OF THE INVENTION

The invention relates to a blank for a tooth replacement part and to a method of producing a tooth replacement part.

### BACKGROUND OF THE INVENTION

It is known to cut tooth replacement parts out of blanks, e.g. by milling.

The blanks usually have simple geometric shapes, such as the shape of a disc with a predetermined thickness.

For producing the tooth replacement parts, material is removed from the blanks from both the topside and the underside of the blank (whereby the underside is made accessible for the machining, for example, by turning the blank upside down) so as to give the tooth replacement part the desired shape.

The expenses for the blank material are considerable, so that it is an object of the present invention to provide a blank and a method of producing a tooth replacement part, wherein less blank material is necessary.

### BRIEF SUMMARY OF THE INVENTION

This object is achieved with a blank according to claim 1, a method according to claim 8 and a set according to claim 13. Preferred embodiments are disclosed in the dependent claims.

The blank comprises a first section (such as the upper part) which is characterized in that its surface already has the desired shape. The upper part is that part of a tooth that is visible on natural teeth because it is not covered by gums. Therefore, the blank may already have the structure of the occlusal surface of a tooth and of adjacent regions thereof on one side or on one surface or in one section, respectively. A blank for a tooth replacement part can have in one section, for example, the shape of a section of a tooth replacement part which is provided for covering it with an occlusal surface and the other visible parts of a tooth. This part of a tooth replacement part is also called upper part.

The rest (the second section) of the blank has a simple geometric shape, so that a material stock is available which can be machined into the desired shape. The shape of the bottom part is, for example, columnar, whereby the cross-section may be square, rectangular, circular, elliptical, triangular or the like. It may also have rounded corners. Also, it is possible that the cross-section corresponds to the contour of the upper part when looking in the direction to the occlusal surface.

The blank may comprise one or more of the materials such as plastics, metal, special steel, ceramics, zirconium oxide etc. Combinations of these materials are also possible.

Particularly advantageous is a blank having different colorings at different places. As natural teeth are usually not single-colored, but have different colorings at different places, it is an advantage if the blank likewise has different colorings at different places. The different colorings need not be applied to the entire blank, but advantageously only to the first section. Here, for example, such a coloring is relevant, where the topside has a darker coloring in cavities and/or grooves and/or gaps, because this is the normal case with natural teeth. The coloring may be provided on the surface only, while it is also possible that the blank is at least partially dye-penetrated (especially in the region of the first section).

In one advantageous embodiment the blank comprises projections and/or cavities by means of which the blank can be held. The projections and/or cavities can be provided, for example, on the sides to allow a machining of both the first and the second section. To this end, specifically cavities and/or projections at the change-over from the first to the second section are advantageous. Advantageous are at least two, three, four or more cavities and/or projections, which are preferably provided at different sides of the blank so as to obtain a good hold of the blank. The blank may be held with chuck jaws or other clamps or the like on the projections and the cavities.

In the method of producing a tooth replacement part a blank is given the desired shape of a tooth replacement part in a machining process, whereby only parts or one part of the blank, respectively, have to be machined while another part or other parts, respectively, may remain unmachined because they already have the desired final shape.

This method allows a faster production of a tooth replacement part, which can simultaneously be performed with a more effective use of the blank material.

Here, specifically such a method is advantageous in which the portion of the tooth replacement part forming the occlusal surface or facing towards the occlusal surface, respectively, remains unmachined. However, should the necessity arise, smaller adaptations are possible, for example, to adapt the tooth replacement part exactly to a tooth gap or to the counter-teeth, respectively.

Moreover, a method is advantageous in which the machining of the blank is accomplished only out of a half-space. More advantageously, the machining is accomplished only out of one direction, which is possible, for example, with a three-axis milling machine. The direction is called advance direction. Specifically advantageous is such a method in which the blank does not have to be rechecked or turned around, but can still be machined with one milling head only. This becomes possible because one portion of the blank already has the desired shape and need no longer be machined. By this, tooth replacement parts can be produced relatively fast and the procedure is substantially more easy.

The tooth replacement part produced with said method may be an inlay, an overlay, a small cap, a crown, a cover, a bridge or any other component of a tooth replacement part, for example, also a part of an implant.

A tooth replacement part for a given tooth position, e.g. the foremost or any other bicuspid tooth, the canine tooth or a specific incisor, normally requires different blanks. However, different blanks may also be provided for one specific tooth position (e.g. for the first bicuspid tooth), from which one will be chosen. They may differ both in shape and additionally or alternatively in their coloring.

The selection of a blank from a plurality of blanks for a specific tooth position, said different blanks differing in shape, usually allows the selection of a blank matching the shape of the counter-tooth, with a corresponding topside.

In said method, a tooth replacement part finished in respect of the shape can also be correspondingly dyed or colored, respectively.

A set comprises, for example, one of the above-described blanks. The set further comprises at least one counterpart adapted to the first section or to the second section. By this, the blank can be held on the counterpart to machine the accessible portion of the blank, e.g. by milling.

Different counterparts for a blank may be provided so as to have, at all times, different portions of the blank accessible for the machining. Thus, for example, two, three or more counterparts may be provided, which are adapted to the shape of the first or second section while leaving accessible different portions of the first and/or second section.

### BRIEF DESCRIPTION OF THE DRAWINGS

Advantageous embodiments of the invention are disclosed in the accompanying drawings. In the drawings:

FIG. 1 shows a schematic three-dimensional view of different blanks;

FIG. 2 shows a schematic three-dimensional view of a tooth replacement part;

FIG. 3 shows a schematic three-dimensional view of a second tooth replacement part

FIG. 4 shows a schematic three-dimensional view of a blank for a bridge consisting of two members:

FIG. 5 shows a schematic view of teeth as well as different blanks;

FIG. 6 shows a schematic three-dimensional view of a blank comprising a cavity and a projection;

FIG. 7 shows a schematic three-dimensional view of a counterpart.

### DETAILED DESCRIPTION OF THE INVENTION

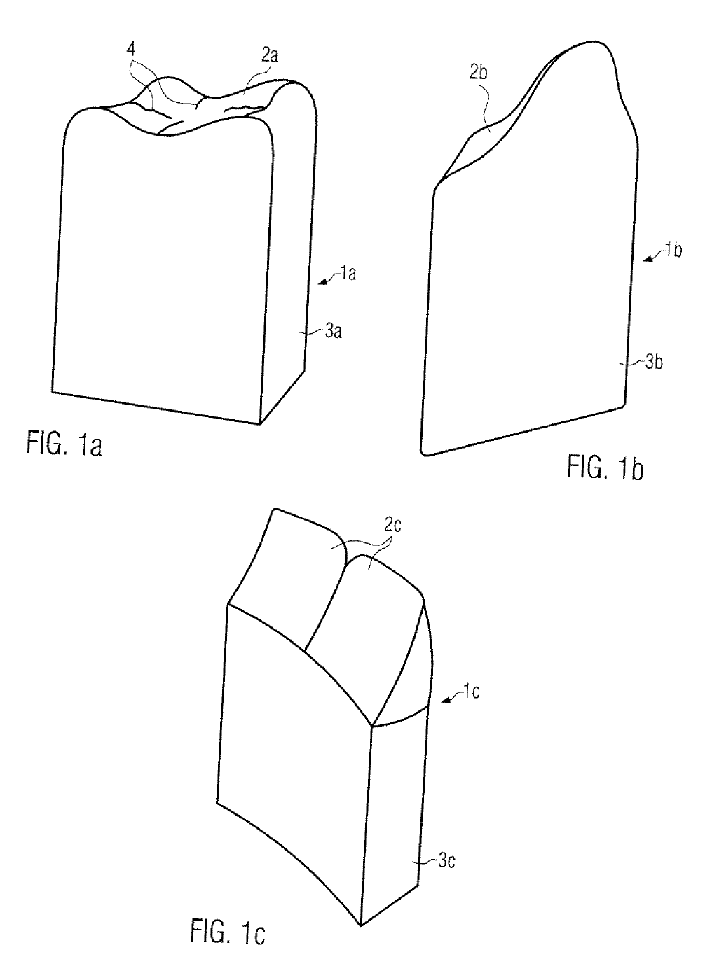

FIG. 1a shows a blank 1a for a tooth replacement part. The blank 1a comprises a topside 2b which corresponds to the occlusal surface of a bicuspid tooth. The blank 1a further comprises an bottom part 3a having a rectangular cross-section and being columnar.

FIG. 1b shows a blank that can be suited for a canine tooth. The blank 1b comprises a topside 2b which corresponds to the occlusal surface of a canine tooth. The bottom part 3b has a columnar shape, with the cross-section thereof being round or irregular, respectively. A top view (in FIG. 1b from above) onto the upper part 2b shows an approximately semicircular cross-section with rounded corners.

FIG. 1c shows a blank for a tooth replacement part which can replace two teeth (here two incisors). In general, the blank may be embodied for the production of a tooth replacement part to replace one, two, three, four or more teeth.

The upper part 2c has the shape of two adjacent incisors. The bottom part 3c of the blank 1c has a substantially rectangular cross-sectional shape, but is slightly bent. This shape can be seen in the top view from above onto the occlusal surfaces 2c.

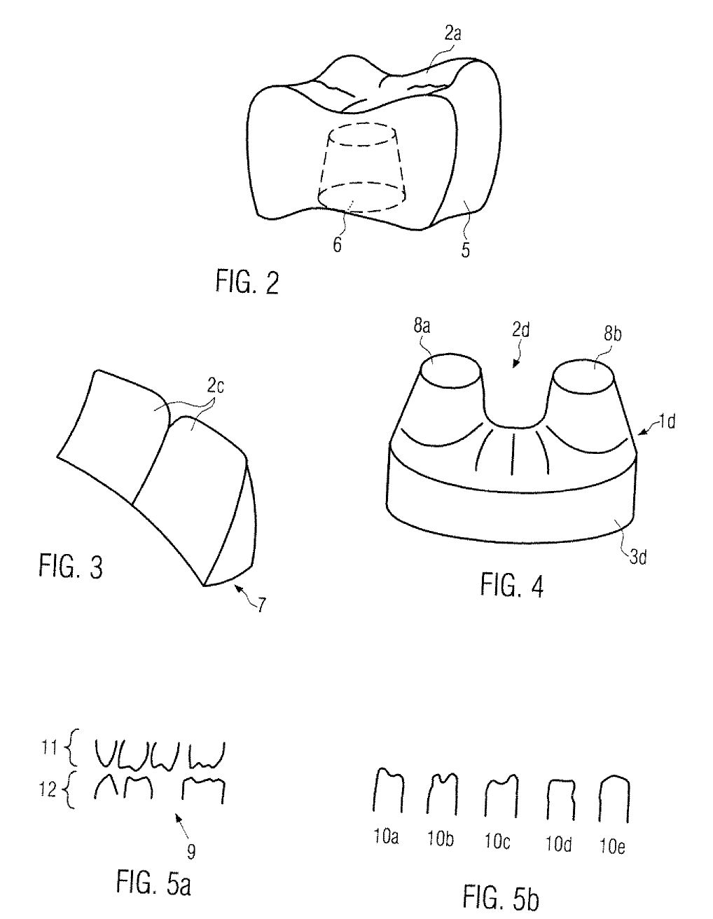

FIG. 2 shows a finished tooth replacement part as produced from blank 1a (see FIG. 1a). The upper part thereof 2a is unchanged. The blank 1a was machined merely on the underside so as to obtain the desired shape 5. This shape shows a cavity 6 by means of which the tooth replacement part can be fitted onto a bridge or an implant stud.

FIG. 3 correspondingly shows a tooth replacement part as can be produced from the blank 1c. The upper part 2a is unchanged in its shape, merely the bottom part 7 was machined.

FIG. 4 shows a blank 1d for the production of a bridge. The bridge comprises two frusto-conical elevations 8a, 8b on its topside. Covers, which optically resemble teeth, may be fitted onto these elevations. These covers then comprise the occlusal surfaces.

The bottom part 3d has a columnar shape with an approximately elliptical cross-section.

FIG. 4 shows a blank 1d for a bridge consisting of two members. However, also bridge blanks having three, four, five or more members may be provided.

FIG. 5a schematically shows a row of teeth 11 corresponding to the teeth of the upper jaw. Reference numeral 12 designates the associated teeth of the lower jaw. At position 9 one tooth is missing, which is to be replaced by a tooth replacement part. The tooth gap is located at the position of the second bicuspid tooth. For the position of the second bicuspid tooth blanks having the shapes as illustrated in FIG. 5b may be provided.

The blank 10a comprises two differently high bumps on its topside, while the blank 10b comprises two bumps of approximately the same height. At least the topside of blank 10c is approximately laterally reversed to blank 10a and likewise comprises two differently high bumps. The blank 10d has a substantially flat topside, while blank 10e has a cambered topside.

For the tooth gaps 9 in FIG. 5a, for example, a blank having the topside of blank 10a would be suited, because it would favorably match the counter-teeth 11.

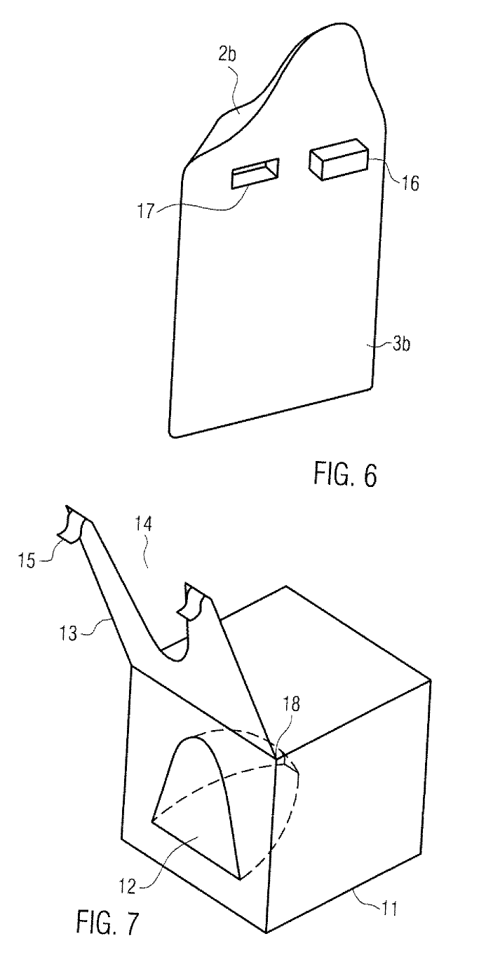

FIG. 6 shows a blank 1, which is exemplarily provided with a projection 16 and a cavity 17. Advantageous is a blank 1 which comprises only projections 16 or only cavities 17, because this allows an easier holding of the blank 1. FIG. 6 only shows two holding elements (one cavity and one projection) both located on the same side. On the two opposite sides of FIG. 6 or on only one of these sides one or more holding devices are provided. On a blank having a substantially triangular cross-section one, two or three holding devices may each be provided on one, two or three sides. Correspondingly, a blank having a substantially quadrangular cross-section may be provided with one, two or three holding devices on one, two, three or four sides. Further advantageous is an arrangement of holding elements on opposite sides.

It is further advantageous if the holding devices are provided at the change-over between the first and second section. Holding at these locations allows that the first and/or the second sections remain substantially freely accessible for the machining.

The projections 16 may be removed in a final machining step.

FIG. 7 shows a counterpart 11, which may form a set together with the blank.

The counterpart 11 comprises a receptacle 12 which is adapted to the shape of the blank. In FIG. 7 a counterpart is shown, the receptacle of which is adapted to the first section of the blank of FIG. 1b or 6. The receptacle 12 need not be a precise female mold of a part of the shape of the blank, but merely has to be adapted to allow the holding of the blank. However, such a female mold is optimal for this purpose.

The receptacle may be adapted to both the first and the second section, but also to only a portion thereof. The respectively exposed portion can then be machined correspondingly.

In FIG. 7, the counterpart 11 comprises a clamp 13 which is pivotally mounted about the axis 18. This clamp 13 can be pivoted to the side of the counterpart on which the receptacle 12 comprises an opening. For holding a blank, the blank can have, for example, projections 16 (see FIG. 6) on its periphery which, upon inserting the blank into the receptacle, rest on the surface of the counterpart 11 or are slightly spaced away from it when the blank is inserted. After the insertion of the blank, the clamp 13 can be pivoted, due to the recess 14, past the blank toward the opening of the receptacle 12 (in FIG. 7 downwards), whereby it then presses the blank with the projections into the receptacle 12, so that a firm grip is guaranteed. Other shapes and types of clamps or the like are possible to hold the blank in the counterpart 11. Also, clamps may be provided which can be pivoted into cavities on the blank side so as to hold the blank.

The counterpart 11 in FIG. 7 encompasses the blank at least partially on the entire periphery. It is also possible, however, that the counterpart 11 comprises recesses and/or holes, which allow a machining also of that section of the blank that is held by the counterpart. Thus, for example, the leading third of the counterpart in FIG. 7 may be missing, so that the receptacle 12 is accessible also from the front side. Then, however, the blank is still held by the counterpart 11, while the corresponding section of the blank is accessible for the machining. With other counterparts, in which—as compared to FIG. 7—for example, the upper, lower or trailing third or the right half are missing (so that the top of the blank projects out of the hole of the counterpart on the right), other sections of the blank may be accessible, although the blank is always held on the same (here, the first) section only.

1. A blank for a tooth replacement part, comprising:
a first section having a shape of a section of a tooth or a tooth replacement part, and
a second section comprising a material stock, which can be machined to a desired shape, e.g. by milling it off.

2. The blank according to claim 1, characterized in that the first section corresponds to the upper part of a tooth or a tooth replacement part.

3. The blank according to claim 1, characterized in that the second section has an approximately columnar shape, wherein the cross-section corresponds to the contour of the first section in a top view or is square, rectangular, circular, elliptical or triangular and possibly has rounded corners.

4. The blank according to claim 1, characterized in that the blank comprises at least one of the materials plastics, metal, special steel, ceramics or zirconium oxide.

5. The blank according to claim 1, characterized in that the blank has different colorings at different places.

6. The blank according to claim 5, characterized in that the colorings in cavities and/or grooves and/or gaps in the first section are darker than in other places.

7. The blank according to claim 1, characterized in that the blank comprises holding elements such as projections and/or cavities, preferably on one or more sides corresponding to tooth sides, and/or on or at the change-over from the first to the second section.

8. A method of producing a tooth replacement part, wherein a blank is machined by a removing process such as milling or laser machining to obtain a desired shape of a tooth replacement part, wherein only portions of the blank are machined while other portions remain unmachined because they already have the desired final shape.

9. The method according to claim 8, characterized in that the topside of the tooth replacement part remains unmachined.

10. The method according to claim 8, characterized in that the machining of the blank is accomplished only from one direction.

11. The method according to claim 8, characterized in that the tooth replacement part is an inlay, an overlay, a small cap, a crown, a cover, a bridge or any other component of a tooth replacement part such as of an implant.

12. The method according to claim 8, characterized in that the blank is selected from a plurality of blanks.

13. A set, comprising:
at least one blank according to claim 1, and
at least one counterpart, which is provided with a receptacle for holding the blank adapted at least partially to the first section and/or to the second section.

14. The set according to claim 13, characterized in that the counterpart comprises holding devices such as clamps, which can engage the blank, specifically projections and/or cavities, to hold the blank in the counterpart.
